(19) United States
(12) Patent Application Publication
(10) Pub. No.: US 2024/0306814 A1
(43) Pub. Date: Sep. 19, 2024

(54) THREE-IN-ONE ROTATABLE KITCHEN SET

(71) Applicant: A&C FUTURE, INC., Newport Beach, CA (US)

(72) Inventors: Zhuangboyu Zhou, Santa Ana, CA (US); Shoue CHEN, Irvine, CA (US); Ju Gao, Newport Beach, CA (US); Jiuqi Wang, Santa Ana, CA (US); Sichen Li, Santa Ana, CA (US); Pengcheng Wang, Irvine, CA (US); Han Qin, Newport Beach, CA (US); Jiayang Qin, Newport Beach, CA (US)

(73) Assignee: A&C FUTURE, INC., Newport Beach, CA (US)

(21) Appl. No.: 18/186,042

(22) Filed: Mar. 17, 2023

(51) Int. Cl. A47B 49/00; A47B 77/08; B60P 3/34

(52) U.S. Cl. CPC A47B 49/004; A47B 49/008; A47B 77/08; B60P 3/34; F24C 15/30; F25D 23/10

(57) ABSTRACT

A three-in-one storage solution that reduce the space cost in a relatively small space, such as a kitchen in an RV. For example, three kitchen functions can be included in the device. A three-in-one cabinet can include a kitchen set (such as a cook top, oven, stove light, microwave, and the like), a refrigerator and a storage cabinet. These three pieces of furniture are rarely needed to be used at the same time. Therefore, it is possible to save space by combining these three pieces of furniture together in a rotatable mechanism, where a wall-space length of only one of these items is needed and the device can rotate between each of the devices as each one is needed.

### BACKGROUND OF THE INVENTION

### 1. Field of the Invention

Embodiments of the invention relate generally to storage solutions. More particularly, embodiments of the invention relate to a rotatable storage solution that may be used to move appliance or storage elements between use and non-use positions.

### 2. Description of Prior Art and Related Information

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Storage solutions are often lacking in small homes, such as mobile homes, so-called tiny houses, and recreational vehicles (RVs), for example. Kitchens can take a significant amount of space, where ovens, refrigerators and cabinets are often provided in a linear fashion along a wall. Such a conventional linear arrangement can occupy much wall space, which can be minimal to begin with in such small structures.

In view of the foregoing, there is a need for a storage solution that can hold a plurality of different items that are selectively accessible.

### SUMMARY OF THE INVENTION

Embodiments of the present invention aim to solve the aforementioned problems in conventional home layout and storage spaces by reducing the space cost in a relatively small space, such as a kitchen in an RV. In some embodiments, three kitchen functions can be included in the device of the present invention. A three-in-one cabinet can include a kitchen set (such as a cook top, oven, stove light, microwave, and the like), a refrigerator and a storage cabinet. These three pieces of furniture are rarely needed to be used at the same time. Therefore, it is possible to save space by combining these three pieces of furniture together in a rotatable mechanism, as provided in greater detail below, that includes an inner turntable structure, vertically divided into a plurality of sections (such as three sections) and an outer shell that permits the inner turntable to rotate therein, where a front opening of the outer shell permits access to at least one of the vertically divided sections of the inner turntable.

Embodiments of the present invention provide a rotatable storage unit comprising an inner turntable divided vertically into a plurality of sections; an outer shell permitting rotation of the inner turntable therein; a front opening of the outer shell permitting access to at least one of the plurality of sections accessible to a user at a given time, wherein the inner turntable is movable to permit the user to access each of the plurality of sections, wherein at least one of the plurality of sections is inaccessible to the user.

Embodiments of the present invention provide a rotatable kitchen unit, comprising an inner turntable divided vertically into a plurality of sections; an outer shell permitting rotation of the inner turntable therein; a front opening of the outer shell permitting access to at least one of the plurality of sections accessible to a user at a given time, wherein the inner turntable is movable to permit the user to access each of the plurality of sections, wherein at least one of the plurality of sections is inaccessible to the user; and each of the plurality of sections include a kitchen functionality, including at least one of a refrigerator, an oven, a cooktop, a microwave and a cabinet.

Embodiments of the present invention provide a three-in-one rotatable kitchen unit, comprising an inner turntable divided vertically into a first section, a second section and a third section; an outer shell permitting rotation of the inner turntable therein; and a front opening of the outer shell permitting access to one of the first, second and third sections accessible to a user at a given time, wherein the inner turntable is movable to permit the user to access each of the first, second and third sections, wherein at least one of the first, second and third sections is inaccessible to the user; and each of the first, second and third sections include a kitchen functionality, including at least one of a refrigerator, an oven, a cooktop, a microwave and a cabinet.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1A illustrates a perspective view of a three-in-one cabinet, showing a kitchen set in a use position, according to an exemplary embodiment of the present invention;

FIG. 1B illustrates a perspective view of a three-in-one cabinet, showing a refrigerator in a use position, according to an exemplary embodiment of the present invention;

FIG. 1C illustrates a perspective view of a three-in-one cabinet, showing storage cabinets in a use position, according to an exemplary embodiment of the present invention;

FIG. 2A illustrates a perspective view of an inner structure of the three-in-one cabinet of FIGS. 1A through 1C;

FIG. 2B illustrates a side view of the inner structure of FIG. 2A;

FIG. 3 illustrates a perspective view of an outer structure of the three-in-one cabinet of FIGS. 1A through 1C; and

FIG. 4 illustrates a perspective view of the assembled three-in-one cabinet, showing a kitchen set in a use position, according to an exemplary embodiment of the present invention.

The illustrations in the figures may not necessarily be drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE PREFERRED EMBODIMENTS AND BEST MODE OF INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising.” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, embodiments of the present invention provide a three-in-one storage solution that can reduce the space cost in a relatively small space, such as a kitchen in an RV. For example, three kitchen functions can be included in the device. A three-in-one cabinet can include a kitchen set (such as a cook top, oven, stove light, microwave, and the like), a refrigerator and a storage cabinet. These three pieces of furniture are rarely needed to be used at the same time. Therefore, it is possible to save space by combining these three pieces of furniture together in a rotatable mechanism, where a wall-space length of only one of these items is needed and the device can rotate between each of the devices as each one is needed.

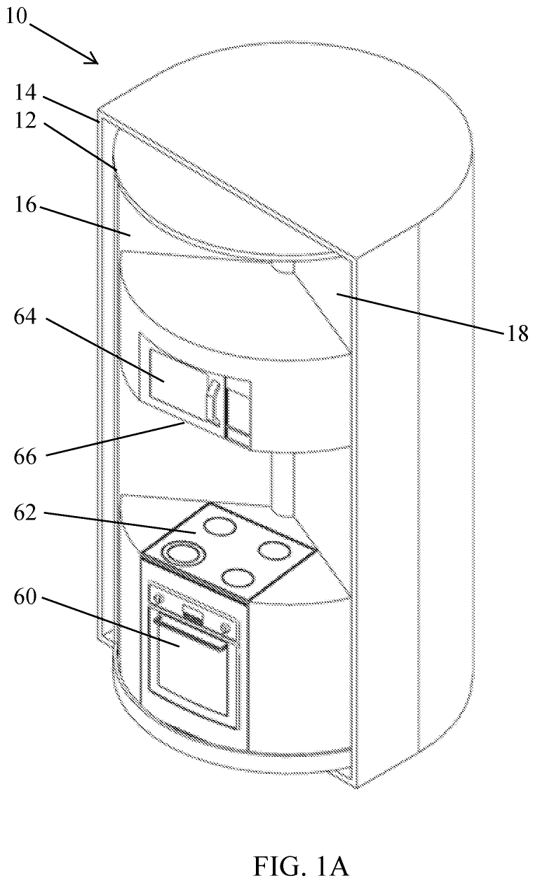

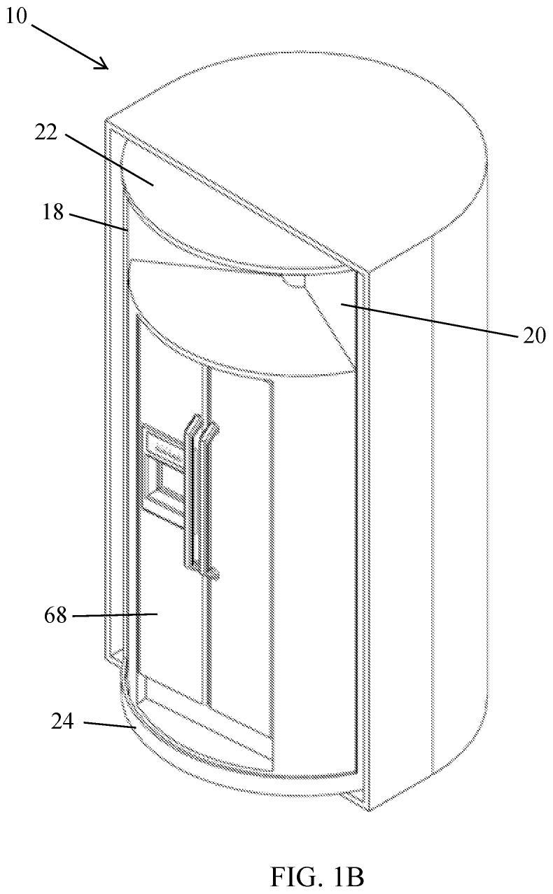

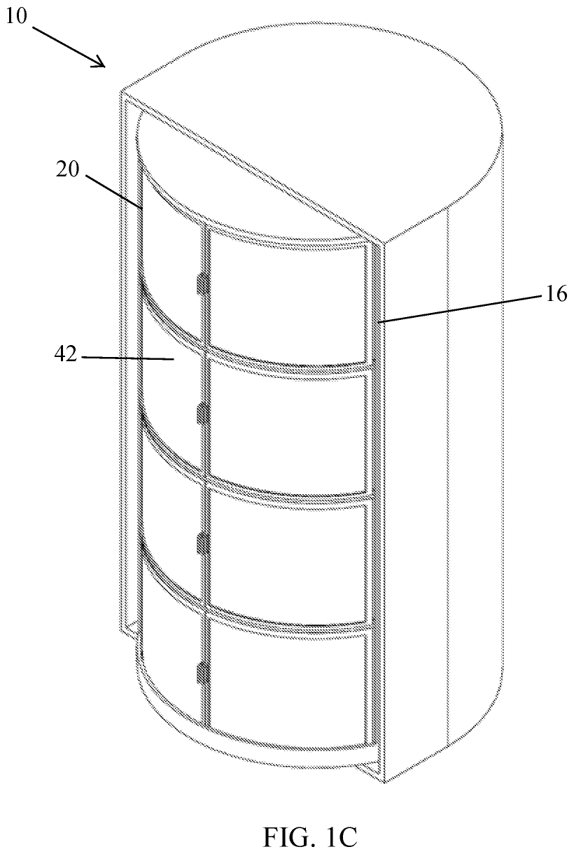

Referring to FIGS. 1A through 1C, a three-in-one cabinet 10 (also referred to as cabinet 10) can include an inner turntable 12 and an outer shell 14. The outer shell 14 may span between a floor and a ceiling of a structure, such as a kitchen in a recreational vehicle. The inner turntable 12 may be divided into thirds by vertical partitions 16, 18, 20. Of course, depending on the application, the inner turntable 12 may be divided in half, quarters, or the like. The inner turntable 12 may include a top member 22 and a bottom member 24, that are typically formed in a circular shape, between which the vertical partitions 16, 18, 20 extend.

The inner turntable 12 can be configured to retain a kitchen set between vertical partitions 16, 18, as shown in FIG. 1A. The kitchen set can include an oven 60, a cook top 62 (which may be integrated into the oven 60), a microwave 64, a cook light 66, and the like. In some embodiments, a storage space may be provided above the microwave 64, as shown in FIG. 1A. This space may be covered by a door, such as a rolling door, an accordion door, a removable cover, or the like. Between vertical partitions 18, 20, a space may be provided for a refrigerator 68, as shown in FIG. 1B. Between vertical partitions 20, 16, a cabinet storage system 42 may be provided. Any number of cabinets may be provided, such as four vertically stacked storage spaces, as shown in FIG. 1C. Each storage space can include an outer door, such as a sliding door, a rolling door, a removable door, an accordion door, or the like.

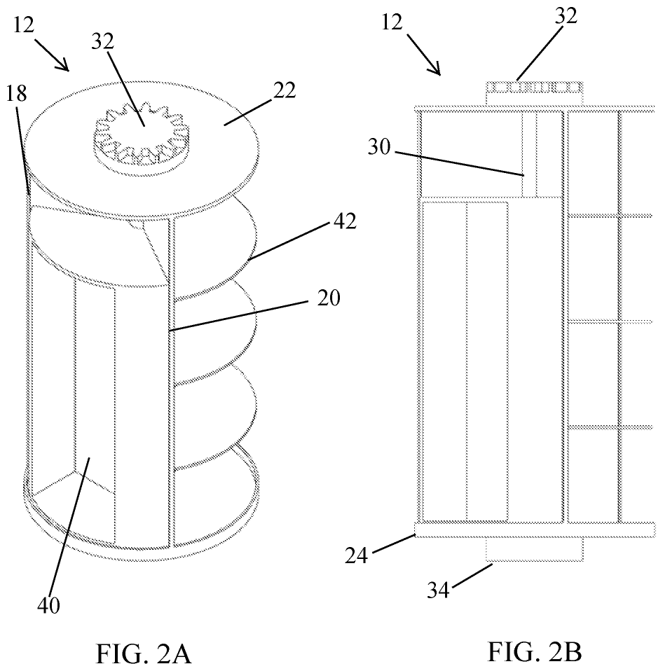

Referring to FIGS. 2A and 2B, details of the inner turntable 12 are shown. A central vertical axis 30 may extend down a central region of the inner turntable 12. In some embodiments, electric and gas connections, as needed, may be disposed along the central vertical axis 30.

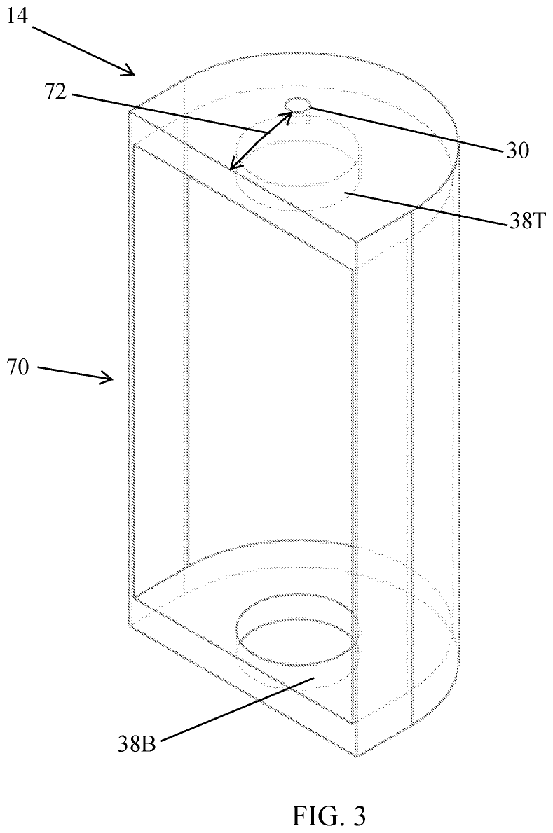

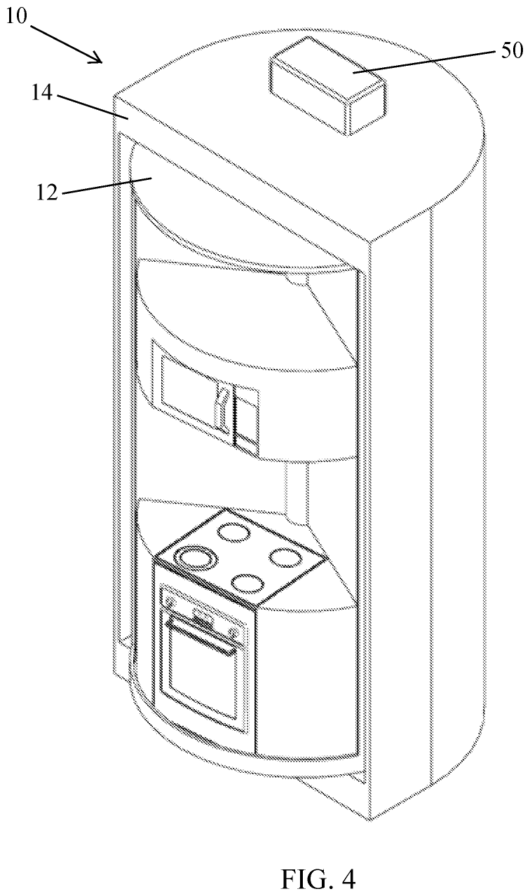

A driven mechanism, such as a gear 32, may be provided at a top end of the inner turntable 12, on top of the top member 22. The gear 32 may be turned by a driving mechanism, such as a motor 50 (see FIG. 4) to turn the inner turntable 12, while the outer shell 14 remains stationary. In FIG. 2A, a refrigerator space 40 is shown without the refrigerator 68 present. Below the bottom member 24, a protrusion 34 may extend, generally coaxial with the central vertical axis 30. The protrusion 34 may fit into a lower space 38B in the outer shell 14 (see FIG. 3). The protrusion 34 may include bearings, wheels, or the like (not shown) to help facilitate rotation of the inner turntable 12 relative to the outer shell 14.

Referring also to FIG. 3, an upper space 38T may be provided in the top of the outer shell 14. The upper space 38T may receive the gear 32 and may provide the connection between the gear 32 and the motor 50. While a gear 32 is shown for driving (rotating) the inner turntable 12, various mechanisms may be used, such as a pulley and belt, a direct motor drive, a magnetic drive, or the like.

As can be seen in FIG. 3, the vertical axis 30 is spaced inward a distance 72 from the front opening 70 of the outer shell 14. In other words, the outer shell 14, in the embodiment of FIG. 3, extends beyond a semi-circle. This is because the inner shell is divided into thirds and only one of the compartments are provided in the front opening 70 at a given time. If the inner shell was divided in half, then the outer shell 14 may be provided more closely to that of a semi-circle. If the inner shell was divided in quarters, then the outer shell 14 may extend even further. In some embodiments, the front opening 70 may be provided to provide access to more than one of the compartments of the inner shell.

While various modules are illustrated and described above (such as the kitchen set, refrigerator and cabinets), various other items may be provided in the three-in-one cabinet, such as a dining table, television/entertainment module, and the like.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Claim elements and steps herein may have been numbered and/or lettered solely as an aid in readability and understanding. Any such numbering and lettering in itself is not intended to and should not be taken to indicate the ordering of elements and/or steps in the claims.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A rotatable storage unit comprising:
an inner turntable divided vertically into a plurality of sections;
an outer shell permitting rotation of the inner turntable therein;
a front opening of the outer shell permitting access to at least one of the plurality of sections accessible to a user at a given time, wherein
the inner turntable is movable to permit the user to access each of the plurality of sections, wherein at least one of the plurality of sections is inaccessible to the user.

2. The rotatable storage unit of claim 1, wherein the plurality of sections is a first section, a second section and a third section.

3. The rotatable storage unit of claim 1, wherein the front opening permits access to one of the plurality of sections at the given time.

4. The rotatable storage unit of claim 1, further comprising:
a driven mechanism at a top of the inner turntable; and
a driving mechanism operable to turn the driven mechanism to permit rotation of the inner turntable relative to the outer shell.

5. The rotatable storage unit of claim 4, wherein the driven mechanism is a gear and the driving mechanism is a motor disposed on the outer shell.

6. The rotatable storage unit of claim 1, further comprising:
a receptacle formed in a bottom surface of the outer shell; and
a protrusion extending from a bottom surface of the inner turntable, the protrusion rotatably fitting into the receptacle.

7. The rotatable storage unit of claim 6, wherein the receptacle and protrusion are coaxial with a central vertical axis of the inner turntable.

8. The rotatable storage unit of claim 7, wherein the central vertical axis is spaced inward from the front opening of the outer shell.

9. The rotatable storage unit of claim 1, wherein the plurality of compartments include a kitchen functionality.

10. The rotatable storage unit of claim 9, wherein the kitchen functionality includes at least one of a refrigerator and a kitchen set.

11. The rotatable storage unit of claim 1, wherein the outer shell extends from a floor to a ceiling within a structure.

12. A rotatable kitchen unit, comprising:
an inner turntable divided vertically into a plurality of sections;
an outer shell permitting rotation of the inner turntable therein;
a front opening of the outer shell permitting access to at least one of the plurality of sections accessible to a user at a given time, wherein
the inner turntable is movable to permit the user to access each of the plurality of sections, wherein at least one of the plurality of sections is inaccessible to the user; and
each of the plurality of sections include a kitchen functionality, including at least one of a refrigerator, an oven, a cooktop, a microwave and a cabinet.

13. The rotatable kitchen unit of claim 12, wherein the plurality of sections is a first section, a second section and a third section.

14. The rotatable kitchen unit of claim 12, wherein the front opening permits access to one of the plurality of sections at the given time.

15. The rotatable kitchen unit of claim 12, further comprising:
a gear at a top of the inner turntable; and
a motor operable to turn the gear to permit rotation of the inner turntable relative to the outer shell.

16. The rotatable kitchen unit of claim 12, further comprising:
a receptacle formed in a bottom surface of the outer shell; and
a protrusion extending from a bottom surface of the inner turntable, the protrusion rotatably fitting into the receptacle,
wherein the receptacle and protrusion are coaxial with a central vertical axis of the inner turntable.

17. A three-in-one rotatable kitchen unit, comprising:
an inner turntable divided vertically into a first section, a second section and a third section;
an outer shell permitting rotation of the inner turntable therein;
a front opening of the outer shell permitting access to one of the first, second and third sections accessible to a user at a given time, wherein
the inner turntable is movable to permit the user to access each of the first, second and third sections, wherein at least one of the first, second and third sections is inaccessible to the user; and
each of the first, second and third sections include a kitchen functionality, including at least one of a refrigerator, an oven, a cooktop, a microwave and a cabinet.

18. The three-in-one rotatable kitchen unit of claim 17, further comprising:
a gear at a top of the inner turntable; and
a motor operable to turn the gear to permit rotation of the inner turntable relative to the outer shell.

19. The three-in-one rotatable kitchen unit of claim 17, further comprising:
a receptacle formed in a bottom surface of the outer shell; and
a protrusion extending from a bottom surface of the inner turntable, the protrusion rotatably fitting into the receptacle,
wherein the receptacle and protrusion are coaxial with a central vertical axis of the inner turntable.
